(19) United States
(12) Patent Application Publication
(10) Pub. No.: US 2007/0260763 A1
(43) Pub. Date: Nov. 8, 2007

(54) INSTALLATION METHOD, PROGRAM, PERIPHERAL DEVICE AND SYSTEM

(75) Inventor: Kouichirou KASAMA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/768,654

(22) Filed: Jun. 26, 2007

Related U.S. Application Data
(63) Continuation of application No. PCT/JP05/00469, filed on Jan. 17, 2005.

(51) Int. Cl. G06F 3/00

(52) U.S. Cl. 710/8

(57) ABSTRACT

When connection of the host and the peripheral device is detected, it is searched whether or not the driver is installed in the host. When the search result shows that the driver is not installed in the host, the driver stored in the storage of the peripheral device is read out and installed in the host. Upon detection of connection of the host and the peripheral device, the storage mode bringing the storage into active state is initialized. Upon detection that the driver has already been installed in the host in the search processing step, or when installation of the driver has been completed in the installation processing; step, the mode is switched over into the peripheral device mode which brings the peripheral device except for the storage into active state.

This application is a continuation of PCT/JP2005/000469 filed Jan. 17, 2005.

### TECHNICAL FIELD

The present invention relates to an installation method, a program, a peripheral device and a system for installing a driver of a peripheral device on an OS. More particularly, the invention relates to an installation method, a program, a peripheral device and a system for processing, upon connecting a peripheral device, by determining whether or not there is present driver installation.

### BACKGROUND ART

When using a peripheral device for a computer, it is conventionally necessary to install, on an OS, a driver which is a special piece of software for controlling the peripheral device in the computer main frame. Such a driver of a peripheral device is usually installed from a portable recording medium such as a CD, or installed by downloading from a server on a network. However, downloading from a special medium or network requires much labor and cost. It is therefore the common practice to store in advance the driver in a storage such as a ROM incorporated in the peripheral device, and upon connecting the peripheral device to the computer main frame, to read out the driver from the storage of the peripheral device to install it in the computer main frame.

However, in this conventional method of storing a driver in a peripheral device and installing it in the computer main frame, irrespective of whether the driver has already been installed or not in the computer main frame, it is the usual practice to perform a process of reading out the driver from the storage and installing it into the computer main frame, upon connecting the peripheral device to the computer main frame. This requires much wasteful time for processing, and the useless installation processing prevents the right of execution to the other processes of the peripheral device, resulting in a problem of a decrease in the operating rate of the peripheral device.

In the conventional driver installing method, even after installing the driver from the peripheral device into the computer main frame, the storage of the peripheral device storing the driver is always in the active state. Along with the active state of the storage, therefore, there is an increase in the power consumption, and simultaneously, check routine and other processing for the storage is constantly required even in the absence of an input/output request. This makes it difficult for the execution right to become available for the other processes of the peripheral device along with the progress of active state of the storage, thus forming a factor causing a decrease in the operating rate of the peripheral device.

It is an object of the present invention to provide an installing method, a program, a peripheral device and a system which permit avoidance of useless installation processing by determining presence or absence of driver installation upon connection of the peripheral device to the computer main frame.

It is another object of the present invention to provide an installing method, a program, a peripheral device, and a system for reducing the power consumption and processing load after the completion of installation of a driver stored in a storage.

### DISCLOSURE OF INVENTION

(Method)

The present invention provides an installing method for installing a peripheral device capable of being connected to a host on the host. The installing method of the present invention comprises:
a search processing step of searching whether or not the drive is installed into the host upon detecting connection of the host and the peripheral device; and
an installation processing step of reading out the driver stored in the storage of the peripheral device upon detecting that the driver is not installed in the host, and installing the driver in the host.

The installing method of the present invention further has a switching step in which, upon detecting connection of the host and the peripheral device, a storage mode bringing the storage into active state is initialized, and upon detecting that the driver is installed in the host in the search processing step, or upon the completion of installation of the driver in the installation processing step, the peripheral device except for the storage is brought into a peripheral device mode of bringing it into an active state.

The switching step comprises supplying power to the storage in the storage mode, and-discontinuing supply of power to the storage in the peripheral device mode.

(Peripheral Device Program)

The present invention provides a program executed by a computer of the peripheral device. This program causes
a computer of a peripheral device to execute:
a search processing step a search processing step of searching whether or not the drive is installed into the host upon detecting connection of the host and the peripheral device; and
an installation processing step of reading out the driver stored in the storage of the peripheral device upon detecting that the driver is not installed in the host, and installing the driver in the host.

The program of the present invention further comprises causing the computer to execute
a step in which, upon detecting connection of the host and the peripheral device, a storage mode bringing the storage into active state is initialized, and
a switching processing step in which, upon detecting that the driver is installed in the host in the search processing step, or upon the completion of installation of the driver in the installation processing step, the peripheral device except for said storage is brought into a peripheral device mode of bringing it into an active state.

In this case, power is supplied to the storage in the storage mode, and power supply is discontinued in the peripheral device mode.

(Host Program)

The present invention provides a program executed by the computer of the host. The program of the present invention further causes the computer of a host capable of being connected to a peripheral device to execute:

a search processing step of searching whether or not the driver of the peripheral device is installed upon detecting connection of the peripheral device; and

an installing step of reading out the driver from the storage of said peripheral device and installing the read-out driver.

The program of the present invention further comprises:

a step installing a storage mode of bringing the storage to an active state, upon detection of connection with the peripheral device, after notifying the peripheral device; and

a switching step of switching to a peripheral device mode of bringing the peripheral device except for the storage into an active state, upon searching of storage of a driver in the search processing step, or upon the completion of installation of the driver in the installing step, after notifying the peripheral device.

In this case, the peripheral device is caused to supply power to the storage in the storage mode, and to discontinue supply of power in the peripheral device mode.

The peripheral device program of the present invention corresponding to this host program causes the computer of a peripheral device connected to a host to execute:

a step of initializing a storage mode for bringing the storage storing a driver into an active state upon receipt of a notice of detection of connection from the host; and

a switching step of switching to a peripheral device mode of bringing the peripheral device into an active state except for the storage upon receipt of an installation search notice of a driver from the host, or upon receipt of an installation completion notice of the driver. In this case, the program causes the peripheral device to supply power to the storage in the storage mode, and to discontinue supply of power in the peripheral device mode.

(Peripheral Device)

The present invention provides a peripheral device capable of being connected to a host. The peripheral device of the present invention comprises:
a storage storing a driver;
a search processing unit which searches whether or not a driver is installed in a host upon detection of connection with the host: and

an installation processing unit which, upon detecting that a driver is not installed in the host, reads out the driver from the storage and installs the read-out driver in the host.

The peripheral device of the present invention further comprises a switching processing unit which, upon detection of connection with the hot, initializes a storage mode of bringing the storage into an active state, and upon search of installation of the driver in the host by the search processing unit, or upon the completion of installation of the driver by said installation processing unit, switches over to the peripheral device mode bringing the peripheral device into an active state except for the storage. In this case, the switching processing unit supplies power to the storage in the storage mode, and discontinues supply of power in the peripheral device mode.

(Computer System)

The present invention provides a computer system comprising a host and a peripheral device connected to the host. In the computer system of the present invention, the peripheral device has a storage storing a driver; and

the host comprises:

a search processing unit which, upon detection of connection of the peripheral device, searches whether or not the driver of the peripheral device is installed; and

an installation processing unit which, upon detection that the driver is not stored, reads out the driver from the storage and installs the read-out driver.

In the computer system of the present invention, the peripheral device further comprises a switching processing unit which, upon receipt of a connection detecting notice from the host, initializes the storage mode bringing the storage into an active state, and upon receipt of an installation detecting notice of the driver from the host, or an installation completion notice of said driver from the host, switches over to peripheral device mode of bringing the storage into an active state except for the storage.

In this case, the switching processing unit supplies power to the storage in the storage mode, and discontinues supply of power to the storage in the peripheral device mode.

According to the present invention, when a driver has already been installed, execution of a useless installation processing can be omitted by searching whether or not the driver has been installed in the host on the peripheral device side, thus permitting improvement of the processability of the peripheral device.

After the completion of installation of the driver, by switching over the mode into a mode of discontinuing operation of the storage storing the driver of the peripheral device, it is possible to improve executability of the peripheral device through elimination of the need for storage processing, and by shutting down the power for the storage, the power consumption of the peripheral device can be reduced.

### BRIEF DESCRIPTION OF DRAWINGS

FIG. 1 is a block diagram of the hardware configuration of the present invention.

FIG. 2 is a block diagram illustrating the functional configuration of a first embodiment of the present invention.

FIG. 3 is a flowchart of the peripheral device processing shown in FIG. 2.

FIG. 4 is a flowchart of the computer processing shown in FIG. 2.

FIG. 5 is a block diagram illustrating the functional configuration of a second embodiment of the present invention.

FIG. 6 is a flowchart of a computer processing shown in FIG. 5.

FIG. 7 is a flowchart of the peripheral device processing shown in FIG. 5.

### BEST MODE FOR CARRYING OUT THE INVENTION

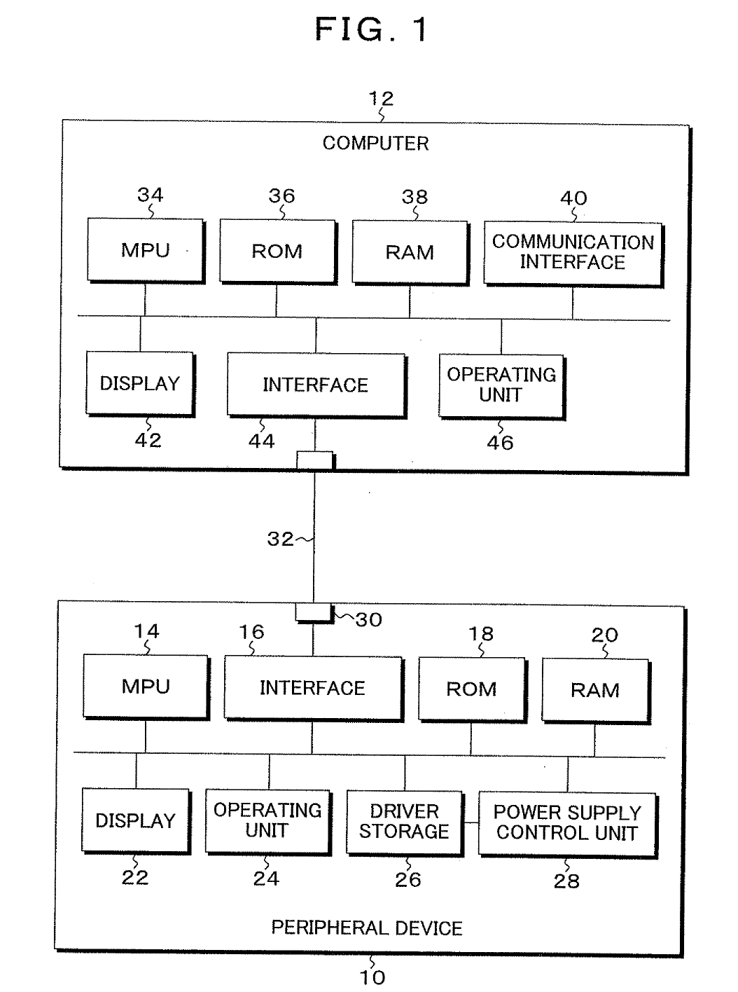

FIG. 1 is a block diagram illustrating the functional configuration of a first embodiment of the present invention. In FIG. 1, the peripheral device 10 to which the driver installation processing of the present invention is applied is used by externally connected via an appropriate interface such as a USB to a computer 12 serving as a host. The peripheral device 10 has an MPU 14, an interface 16, a ROM 18, a RAM 20, a display 22 and an operating unit 24. Further, a dedicated driver storage 26 storing a driver for use of the peripheral device 10 in the computer 12 is provided. As the driver storage, for example, a ROM or the like is used. For the drive storage 26, a special power supply control unit 28 is provided. After the completion of installation of the driver in the computer 12 from the driver storage 26, as clearly described later, power supply from the power supply control unit 28 to the driver storage 26 is shut down to discontinue operation. As such a peripheral device 10, an HDD drive, an MO drive, a cell phone, a PDA, a printer, a scanner and a modem are applicable. The computer 12 serving as the host of the peripheral device 10 has an MPU 34, a ROM 38, a communication interface 40, a display 42, an interface 44 and an operating unit 46. Connection of the peripheral device 10 and the computer 12 is accomplished by connecting connectors 30 and 33 provided for respective interfaces 16 and 44 with a cable 32. As the connectors 30 and 33, in the typical case of the USB interface, USB connectors are used.

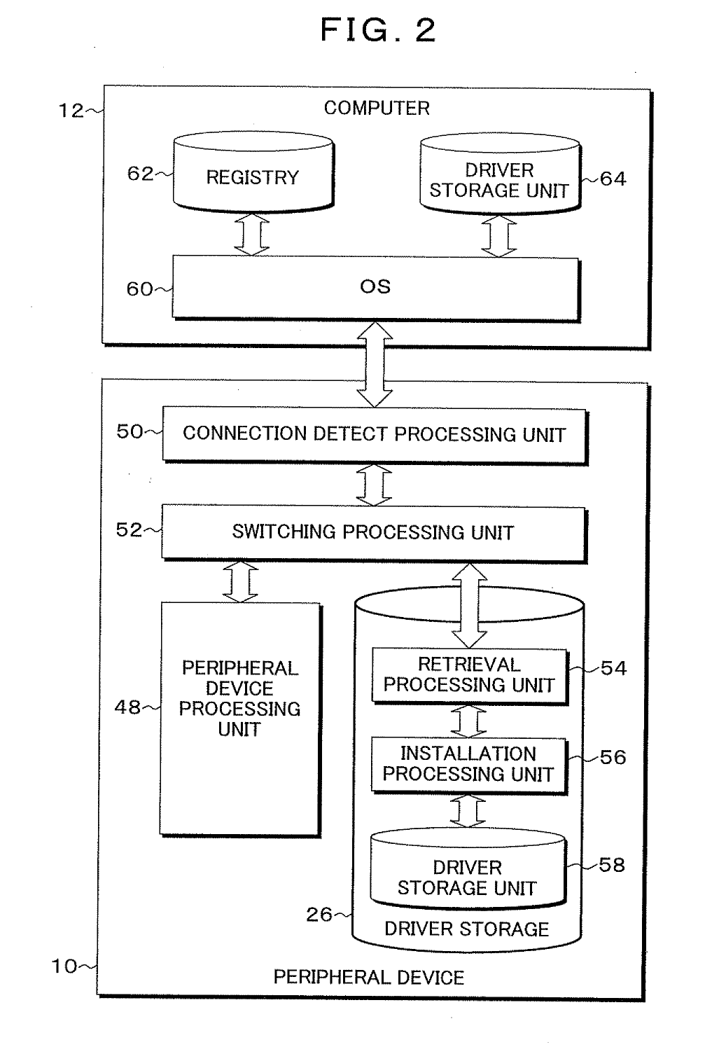

FIG. 2 is a block diagram illustrating the functional configuration of the first embodiment of the present invention. In FIG. 2, a peripheral device processing unit 48, a connection detecting unit 50, a switching processing unit 52, a search processing unit 54, an installation processing unit 56 and a driver storage unit 58 are provided as functions implemented by the execution of a program by an MPU 14 as shown in FIG. 1. The function of the search processing unit 54 and the installation processing unit 56 are implemented by the execution of the program stored in the driver storage 26, and upon discontinuance of operation of the driver storage, the function thereof disappears. On the other hand, an OS 60 is provided on the computer 12 side. As the OS 60, for example, Windows (R) is used. A registry 62 and a driver storing unit 64 are provided for the OS 60. The registry 62 is a file recording settings regarding the software and peripheral devices used on the OS 60. When a new application software program is installed or a new peripheral device is connected to install the driver, the contents of the registry 62 are automatically rewritten. The connection detecting unit 50 provided in the peripheral device 10 detects connection of the peripheral device 10 to the computer 12 and gives a notice thereof to the switching processing unit 52. The switching processing unit 52 switches over between storage mode and peripheral device mode set on the peripheral device 10. In the storage mode, power is supplied to the driver storage 26 to bring it into an active state. In the peripheral device mode, the peripheral device processing unit 48 is brought into an active state except for the driver storage 26. In this case, supply of power to the driver storage 26 is discontinued under control by the power supply control unit 28 of the peripheral device 10 shown in FIG. 1. When receiving a connection detection notice with the computer 12 from the connection detection processing unit 50, the switching processing unit 52 determines whether the operation mode is the storage mode or the peripheral device mode. If in the peripheral device mode, the switching processing unit 52 switches over the mode to the storage mode. The search processing unit 54 searches the driver storing unit 64 of the computer 12, in a state in which the active state of the storage mode is set by the switching processing unit 52, to determine whether or not the driver of the peripheral device 10 is installed. When the search result by the search processing unit 54 shows that the driver is not as yet installed, the installation processing unit 56 reads out the driver of the peripheral device 10 from the driver storing unit 58 and transfers it to the computer 12, thereby executing installation of the driver. When the driver of the peripheral device 10 is installed in the computer 12, the driver is stored in the prescribed driver storing unit 64 as designated by the OS 60, and at the same time, records setting information necessary for operation of the installed driver in the registry 62. On the other hand, when the search result showing the existence of the driver in the computer 12 is obtained in the search processing unit 54, it is not necessary to install the driver. The switching processing unit 52 is therefore instructed to switch over from the storage mode into the peripheral device mode. Switching to the peripheral device mode is similarly conducted also upon the completion of installation of the driver in the computer 12 by the installation processing unit 56. Upon receipt of a notice of switching instruction into the peripheral device mode from the search processing unit 54 or the installation processing unit 56, the switching processing unit 52 switches the mode from the storage mode so far applied into the peripheral device mode, and stops operation of the driver storage 26 through switching into the peripheral device mode. More specifically, as shown as to the peripheral device 10 in FIG. 1, operation of the driver storage 26 is discontinued by shutting down the supply of power to the driver storage 26 under the control of the power supply control unit 28.

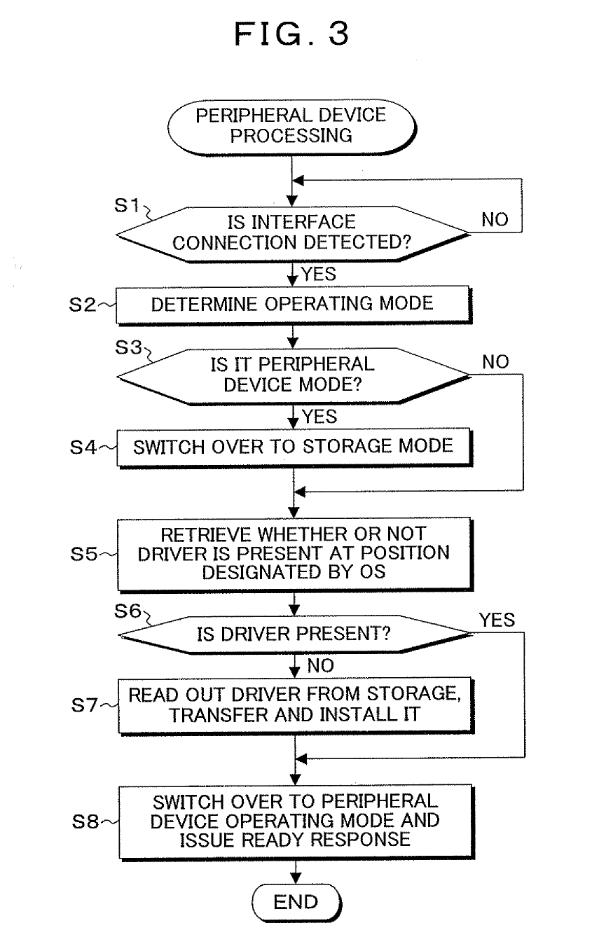

FIG. 3 is a flowchart of the peripheral device processing in the embodiment shown in FIG. 2. In FIG. 3, in step S1, the peripheral device processing checks detection of interface connection of the peripheral device 10 to the computer 12. Upon detecting connection, the process advances to step S2, in which the operation mode of the peripheral device 10 upon detection of connection is determined. Then in step S3, it is checked whether or not the operating mode is the peripheral device mode. If the process is in the peripheral device mode, it is switched over to the storage mode in step S4. If in the storage mode, step S4 is skipped, while keeping the storage mode. Then in step S5, it is searched whether or not there exists the driver of the peripheral device 10 at the designated position as the driver storing unit 64 as specified by the OS 60 of the computer 12, i.e., whether or not installation has been completed. Presence or absence of the driver is thus checked in step S6 through this search. If absent, installation is executed by reading out the driver from the driver storage in step S7 and transferring it to the computer 12. If the driver exists in the computer 12 as a result of search in step S6, execution of installation in step S7 is skipped. In step S8, the mode is switched over from the storage mode so far applied to the peripheral device mode in response to the completion of installation or existence of the driver, and thereafter, a ready response is sent to the computer 12.

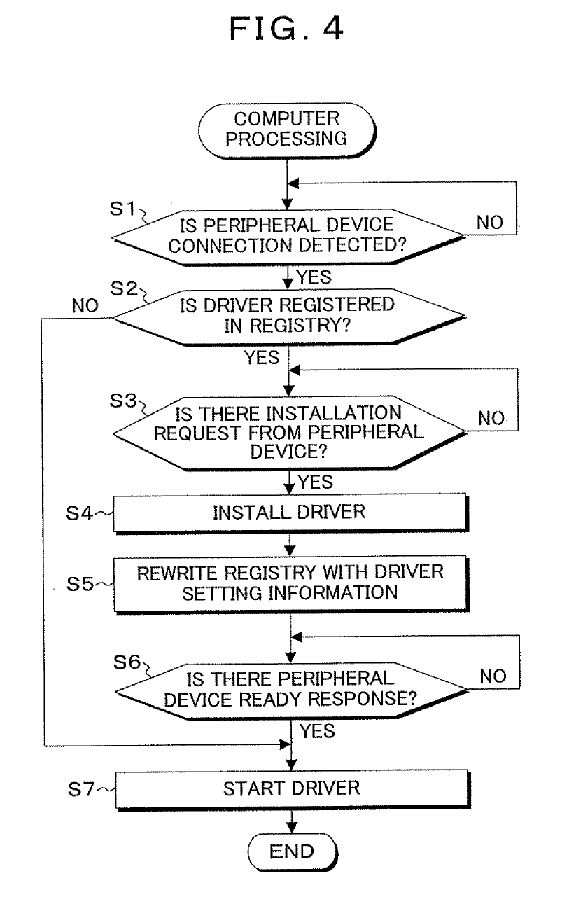

FIG. 4 is a flowchart of computer processing in the embodiment shown in FIG. 2. In FIG. 4, computer processing checks presence of connection detection of the peripheral device 10 in step S1. If connection of the peripheral device 10 is detected, the process advances to step S2, in which presence of registry registration of the driver is checked. If there is no registry registration of the driver, the process goes to step S3, in which the installation request from the peripheral device 10 is checked. If there is an installation request, the driver is installed in step S4 to store the driver in the driver storing unit 64, and in the next step S5, a registry of the driver is prepared. Then in step S6, the ready response from the peripheral device 10 is checked. If there is a ready response, the driver is started in step S7 to complete the series of steps and the process enters into the available state of the peripheral device 10.

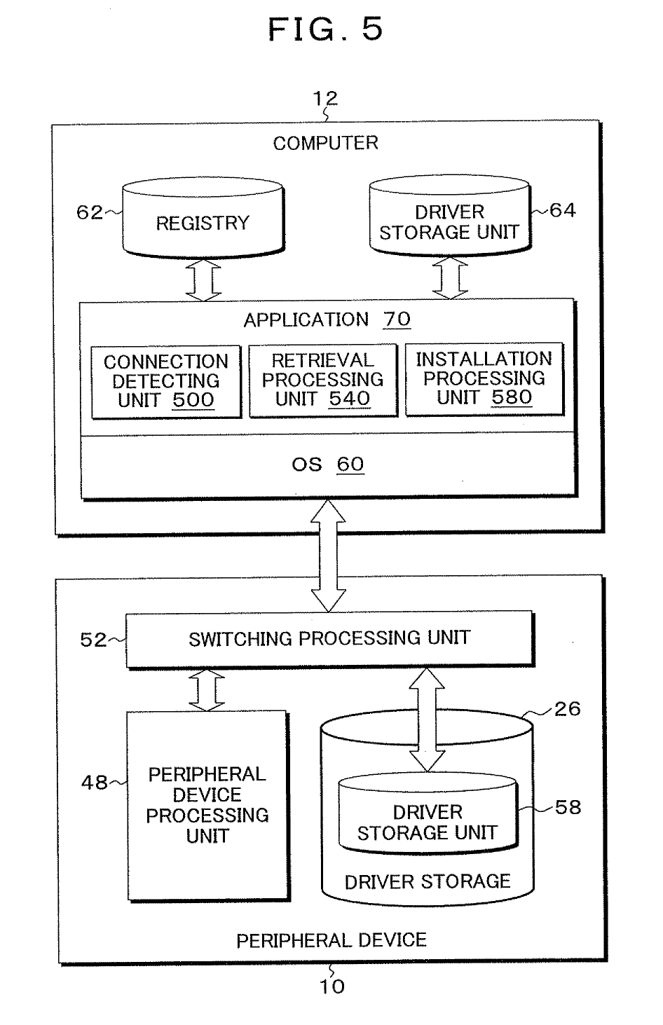

FIG. 5 is a clock diagram illustrating the functional configuration of the second embodiment of the present invention. In FIG. 5, a switching processing unit 52 and the driver storing unit 58 of the driver storage 28 are provided for the peripheral device 10 in this embodiment. Other functions are provided on the computer 12 side. The computer 12 serving as a host of the peripheral device 10 has the OS 60, the registry 62, and the driver storing unit 64. In addition, an application 70 for executing driver installation processing of the present invention is provided. Functions of a connection detecting unit 500, a search processing unit 540 and an installation processing unit 580 are provided for the application 70. The connection detecting unit 500 on the computer 12 side monitors connection of the peripheral device 10. Upon detection of connection, the connection detecting unit 500 gives a connection detecting notice to the switching processing unit 52 of the peripheral device 10. Upon receipt of this connection detecting notice, the switching processing unit 52 of the peripheral device 10 determines whether the current operation mode is the peripheral device mode or the storage mode. If in the peripheral device mode, it is switched over into the storage mode. The search processing unit 54 on the computer 12 side searches whether or not the driver of the peripheral device 10 exists in the driver storing unit 64, i.e., whether or not installation has already been made. If not existent, the non-existence is notified to the installation processing unit 580, and the driver is read out from the driver storing unit 58 of the driver storage 26 of the peripheral device 10 and installed. That is, the driver read out from the peripheral device 10 and transferred is installed and stored in the driver storing unit 64, and simultaneously with this, information necessary for driver operation of the peripheral device 10 is set in the registry 62. When searching the presence of the driver of the peripheral device 10 by the search processing unit 540, the presence of the driver is notified to the switching processing unit 52 of the peripheral device 10. Upon receipt of this notice, the switching processing unit 52 switches over the mode from the storage mode so far applied to the peripheral device mode, and discontinues operation of the driver storage 26 by shutting down supply of power. When the switching processing unit 52 receives an installation completion notice from the installation processing unit 580, the storage mode is similarly switched over to the peripheral device mode, and operation is discontinued through shutdown of supply of power to the driver storage 26.

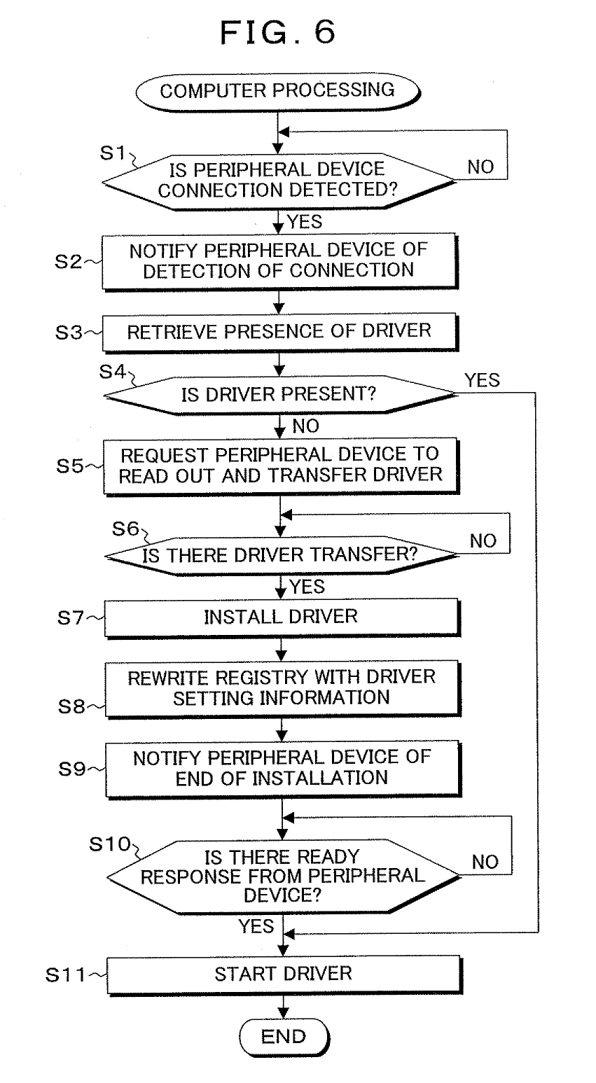

FIG. 6 is a flowchart of computer processing shown in FIG. 5. In FIG. 6, the computer processing checks up connection detection of the peripheral device in step S1. Upon detection of connection, the process advances to step S2, in which connection detection is notified to the peripheral device 10. Then in step S3, it is searched whether or not the driver exists, i.e., whether or not the driver has already been installed. If the driver is not existent in step S4, the process goes to step S5, in which read and transfer of the driver is requested to the peripheral device 10. When transfer of the driver is determined in step S6, the process goes forward to step S7, in which after installing the transferred driver and storing it in the driver storing unit 64, in step S8, registry rewriting of the driver is carried out, in which information necessary for operation of the driver is registered in the registry 62. In step S9, completion of installation is notified to the peripheral device 10. Then in step S10, presence of a ready response of the peripheral device is checked. If the presence of a ready response is determined, the process advances to step S11, in which the installed driver is started, and upon the completion of a series of processes, use of the peripheral device 10 is started.

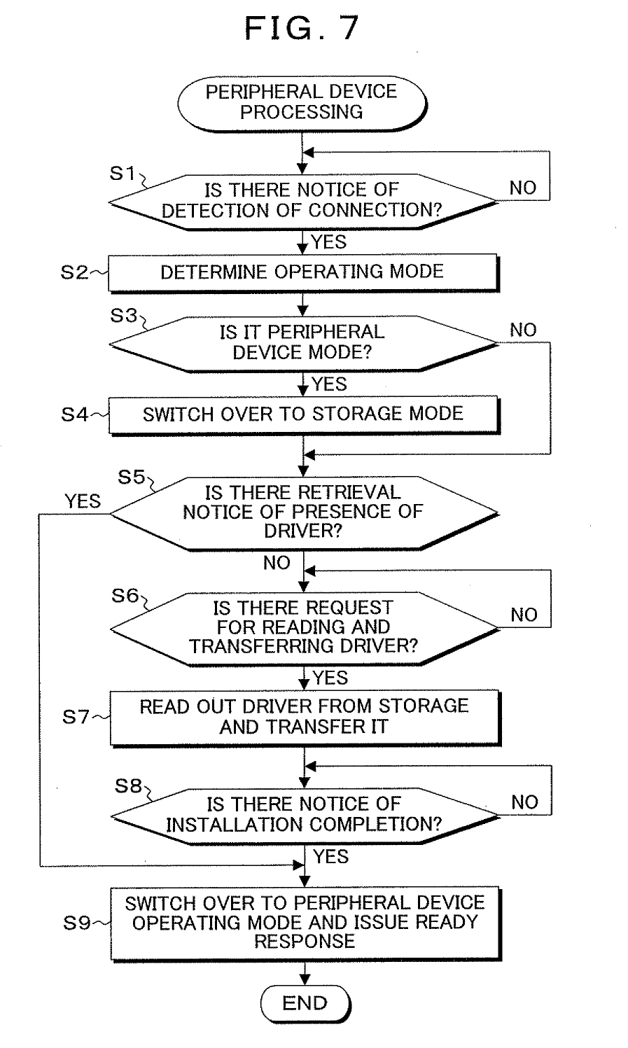

FIG. 7 is a flowchart of peripheral device processing shown in FIG. 5. In FIG. 7, the peripheral device processing checks up the presence of a connection detecting notice from the computer 12 in step S1. If a connection detecting notice is present, the process goes to step S2, in which the operation mode is determined. If the operation mode is the peripheral device mode, it is determined in step S3. In step S4, the mode is switched over to the storage mode. When the storage mode is determined in step S3, step S4 is skipped, and the storage mode is maintained. Then in step S5, presence of an installation search notice showing the presence of the driver is checked from the computer 12 side. If the installation detecting notice shows non-existence of the driver, the process advances to step S6. Upon determination of a driver read and transfer request from the computer 12, the driver is read out from the driver storage and transferred to the computer 12 for installation in step S7. Then in step S8, an installation completion notice from the computer 12 is checked. If an installation completion notice is present, the mode is switched over from the storage mode so far applied to the peripheral device mode in step S9, and then, a ready response is sent to the computer 12. When a search notice showing presence of the driver is found in step S5, steps S6 to S8 are skipped since driver installation is not necessary. The process goes to step S9, in which the mode is switched over to the peripheral device mode, and ready response is started. In the second embodiment of the present invention illustrated in FIGS. 5 to 7, the functions of the connection detecting unit 500, the search processing unit 540 and the installation processing unit 580 necessary for installation of the driver of the peripheral device 10 are implemented as an application 70 on the computer 12 side. This eliminates the necessity of a program for installation stored in the driver storage 26 of the peripheral device 10, thus permitting reduction of the capacity of the driver storage 26. To the extent that the program of processing functions necessary for installation is not executed, it is possible to improve the executing performance of the peripheral device processing unit 48 in the peripheral device 10. In the second embodiment shown in FIG. 5, even after the completion of installation of the driver of the peripheral device 10, or even when the driver of the peripheral device 10 exists in the driver storing unit 64 and installation is not necessary, the application having functions of the connection detecting unit 500, the search processing unit 540 and the installation processing unit 580 is developed on the OS 60. In the case where installation has already been completed or the driver is already existent, execution of the application 70 may be discontinued, and in a state in which the peripheral device 10 is in the peripheral device mode, the functions of the connection detecting unit 500, the search processing unit 540 and the installation processing unit 580 by the application 70 of the computer 12 may be in substantially a deleted state. This makes it possible to avoid a decrease in the executing performance of the computer 12 caused by the presence of the application 70 after the completion of installation.

The present invention provides also a program necessary for installing the driver of the peripheral device 10. This program has program contents in compliance with the flowchart shown in FIG. 3 of the peripheral device 10 regarding the first embodiment. For the computer 12 side, the contents of this program are in accordance with the computer processing shown in FIG. 4.

For the second embodiment shown in FIG. 5, the program of the application 70 on the computer 12 side has contents following the flowchart of the computer processing shown in FIG. 6, and the program of the peripheral device 10 corresponding to the above has contents based on the flowchart of the peripheral device shown in FIG. 7.

In the aforementioned embodiments, when installation has been completed or the driver is present in the host, supply of power to the driver storage 26 storing the driver of the peripheral device 19 is shut down, thereby permitting reduction of power consumption. Without depending upon power shutdown, the bus interface of the driver storage 26 may be separated to cancel access of the MPU 14 to the driver storage 26, thereby improving the execution performance of the peripheral device 10. In this case, to the extent that power supply to the driver storage 26 is not shut down, reduction of the power consumption is limited, but the execution rate can be improved.

The present invention includes appropriate variations without impairing the objects and advantages thereof, and furthermore, is not limited by numeral values shown in the above-mentioned embodiments.

What is claimed is:

1. An installing method of installing a driver of a peripheral device capable of being connected to a host in said host, comprising:
a search processing step of searching whether or not the drive is installed into said host upon detecting connection of the host and the peripheral device; and
an installation processing step of reading out the driver stored in the storage of said peripheral device upon detecting that the driver is not installed in said host, and installing the driver in said host.

2. The installing method according to claim 1, wherein said installing method further has switching step in which, upon detecting connection of said host and the peripheral device, a storage mode bringing said storage into active state is initialized, and upon detecting that said driver is installed in the host in said search processing step, or upon the completion of installation of the driver in said installation processing step, the peripheral device except for said storage is brought into a peripheral device mode of bringing it into an active state.

3. The installing method according to claim 2, wherein said switching step comprises supplying power to said storage in said storage mode, and discontinuing supply of power to the storage in said peripheral device mode.

4. A computer-readable storage medium which stores a program which causes a computer of a peripheral device to execute:
a search processing step a search processing step of searching whether or not the drive is installed into said host upon detecting connection of the host and the peripheral device; and
an installation processing step of reading out the driver stored in the storage of said peripheral device upon detecting that the driver is not installed in said host, and installing the driver in said host.

5. The storage medium according to claim 4, further causing the computer to execute a switching step in which, upon detecting connection of said host and the peripheral device, a storage mode bringing said storage into activated state is initialized, and upon detecting that said driver is installed in the host in said search processing step, or upon the completion of installation of the driver in said installation processing step, the peripheral device except for said storage is brought into a peripheral device mode of bringing it into an activated state.

6. The storage medium according to claim 5, wherein power is supplied to said storage in said storage mode, and power supplied is discontinued in said peripheral device mode.

7. A storage medium which causes the computer of a host capable of being connected to a peripheral device to execute:
a search processing step of searching whether or not the driver of said peripheral device is installed upon detecting connection of said peripheral device; and
an installing step of reading out the driver from the storage of said peripheral device and installing the read-out driver.

8. The storage medium according to claim 7, further comprising:
a step installing a storage mode of bringing said storage to an active state, upon detection of connection with said peripheral device, after notifying said peripheral device; and
a switching step of switching to a peripheral device mode of bringing the peripheral device except for said storage into an active state, upon searching of storage of a driver in said search processing step, or upon the completion of installation of the driver in said installing step, after notifying said peripheral device.

9. The storage medium according to claim 8, wherein said peripheral device is caused to supply power to said storage in said storage mode, and to discontinue supply of power in said peripheral device mode.

10. A computer-readable storage medium which stores a program of causing the computer of a peripheral device connected to a host to execute:
a step of initializing a storage mode for bringing the storage storing a driver into an active state upon receipt of a notice of detection of connection from said host; and
a switching step of switching to a peripheral device mode of bringing the peripheral device into an active state except for the storage upon receipt of an installation search notice of a driver from said host, or upon receipt of an installation completion notice of said driver.

11. The storage medium according to claim 10, wherein said program causes said peripheral device to supply power to said storage in said storage mode, and to discontinue supply of power in said peripheral device mode.

12. A peripheral device comprising:
a storage storing a driver;
a search processing unit which searches whether or not a driver is installed in a host upon detection of connection with the host; and
an installation processing unit which, upon detecting that a driver is not installed in the host, reads out the driver from said storage and installs the read-out driver in the host.

13. The peripheral device according to claim 12, further comprising a switching processing unit which, upon detection of connection with said hot, initializes a storage mode of bringing said storage into an active state, and upon search of installation of said driver in the host by said search processing unit, or upon the completion of installation of the driver by said installation processing unit, switches over to the peripheral device mode bringing the peripheral device into an active state except for said storage.

14. The peripheral device according to claim 13, wherein said
Switching processing unit supplies power to said storage in said storage mode, and discontinues supply of power in said peripheral device mode.

15. A computer system having a host and a peripheral device to be connected to said host; wherein:
said peripheral device has a storage storing a driver; and
said host comprises:
a search processing unit which, upon detection of connection of said peripheral device, searches whether or not the driver of said peripheral device is installed; and
an installation processing unit which, upon detection that said driver is not stored, reads out the driver from said storage and installs the read-out driver.

16. The computer system according to claim 15, wherein said peripheral device further comprises a switching processing unit which, upon receipt of a connection detecting notice from said host, initializes the storage mode bringing the storage into an active state, and upon receipt of an installation detecting notice of the driver from said host, or an installation completion notice of said driver from said host, switches over to peripheral device mode of bringing said storage into an active state except for said storage.

17. The computer system according to claim 16, wherein said switching processing unit supplies power to said storage in said storage mode, and discontinues supply of power to said storage in said peripheral device mode.
